(19) United States
(12) Patent Application Publication
(10) Pub. No.: US 2008/0129135 A1
(43) Pub. Date: Jun. 5, 2008

(54) Motor structure

(75) Inventors: Win-Haw Chen, Taipei (TW); Chen-Yueh Chang, Taipei (TW)

Correspondence Address: RABIN & Berdo, PC, 1101 14TH STREET, NW, SUITE 500, WASHINGTON, DC, 20005, US

(73) Assignee: INVENTEC CORPORATION, Taipei (TW)

(21) Appl. No.: 11/593,503

(22) Filed: Nov. 7, 2006

(51) Int. Cl. H02K 16/04

(52) U.S. Cl. 310/156.35; 310/254

(57) ABSTRACT

A motor structure including a revolving shaft, internal stators, middle rotors, and external stators is provided. The revolving shaft is an axle center, and the internal stators, middle rotors, and external stators are arranged in an outward radial direction. The middle rotors are circularly disposed with magnetic segments, and the poles of adjacent magnetic segments are unlike. Besides, the internal stators are circularly disposed with magnetic generating sections having the like pole and alternatively corresponding to the magnetic segments. The external stators are disposed with magnetic corresponding sections corresponding to the magnetic segments one by one. Moreover, the pole of the magnetic corresponding sections that correspond to the magnetic generating sections is the same as that of the magnetic generating sections. On the other aspect, the pole of the magnetic corresponding sections that do not correspond to the magnetic generating sections is different from that of the magnetic generating sections.

### BACKGROUND OF THE INVENTION

1. Field of Invention

The present invention relates to a motor structure, and more particularly, to a motor structure disposed with a double-stator structure to enhance the magnetic force for driving a rotor.

2. Related Art

As shown in FIGS. 1A and 1B, they are schematic views of a nowadays conventional motor rotating structure. Generally, the motor is classified into two categories of motor structures: one is the first type of motor with an internal stator and an external rotor; and the other is the second type of motor with an internal rotor and an external stator.

A main core of the first type of motor rotating structure consists of an internal stator 110 and an external rotor 120 that are arranged correspondingly. Generally, the external rotor 120 is formed by a permanent magnet or by a metal that undergoes the magnetization process. The external rotor 120 has a plurality of external magnetization segments 121 thereon. Besides, the poles of the external magnetization segments 121 that are adjacent to each other are unlike. The internal stator 110 has a plurality of internal electromagnetic parts 111, which correspond to the external magnetization segments 121 one by one. Usually, a coil is wound on the internal electromagnetic parts 111, so that when the internal electromagnetic parts 111 are powered on, the coil is also powered on to generate a magnetic field. When being powered on, the internal electromagnetic parts 111 alternatively keep switching between the N-pole and the S-pole. Moreover, the poles of the adjacent internal electromagnetic parts 111 are unlike during the same time period. By continuously switching the pole of the internal electromagnetic parts 111, the external rotor 120 is driven under the principle that the like poles are repulsive to each other, while unlike poles are attractive to each other.

The second type of motor rotating structure consists of an internal rotor 140 and an external stator 130. The operating manner of the second type of motor is similar to that of the first type of motor except that the second type of motor is configured in a different manner. A plurality of internal magnetization parts 141 is disposed on the internal rotor 140 and the poles of the adjacent magnetization parts 141 are unlike. The external stator 130 has external electromagnetic parts 131 that correspond to internal magnetization parts 141 one by one. The external electromagnetic parts 131 keep switching between two unlike poles alternatively, the N-pole and the S-pole, once the motor is powered on. Moreover, the poles of the adjacent external electromagnetic parts 131 are unlike during the same time period. The alternated switching of the poles is used to generate a pushing force for the internal rotor.

However, the method has following unavoidable defects. (1) For the first type of motor, when the external rotor is rotated, an auxiliary tool is required to correct the position during the rotation. The external rotor has gradually offset from the axle center if the rotating speed reaches a certain rate while the external rotor is rotated, thus, an offset correcting tool, such as a positioning magnet, is used to assist to fix the external rotor in the rotating position. However, in this way, the external rotor is disturbed by other external forces, and as a result, the rotating speed is difficult to be increased, and the torque is relatively low. (2) For the second type of motor, the internal rotor is made to rotate quickly under a strong pushing force provided by the external stator. However, the shaft diameter of the internal rotor is too small to be applied to various operation fields, thus, the operating fields are always limited, and it's difficult to increase the torque efficiently with a limited shaft diameter, which causes an invisible waster of energy.

### SUMMARY OF THE INVENTION

In view of the above, in order to solve the above problems and to use the rotor and stator structure of the motor itself to achieve the effect that the rotor is stably rotated so as to increase the rotating speed efficiently and to increase the torque when the motor is operated under the pole, the present invention provides a motor structure, wherein a stator is respectively disposed at the internal side and external side of the rotor. Thus, the pole pushing force or the pole pulling force for the rotor are generated simultaneously to increase the rotating speed of the rotor. Moreover, a double stator structure provides a larger magnetic force to directly increase the torque of the motor. Besides, a balancing effect is achieved under both the pushing forces applied to the rotor by the internal and external stators, which enables the rotor to rotate stably without any offsets.

The present invention provides a motor structure, which comprises a housing, a middle rotor, an internal stator, and an external stator. The middle rotor includes a revolving shaft and an annular magnetic section that are coaxially fitted to each other. The revolving shaft is pivotally mounted at the housing. Just as the name implies, the annular magnetic section mainly has an annular structure. A plurality of magnetic segments is circularly disposed on the annular magnetic section, and the poles of adjacent magnetic segments are unlike.

The internal stator is secured to the housing and has a plurality of magnetic generating sections with the like pole. The magnetic generating sections are circularly disposed on the internal side of the annular magnetic section coaxially. Besides, the magnetic generating sections alternately correspond to the magnetic segments. The magnetic generating section includes a pillar and a coil that surrounds the pillar. Moreover, once being powered on, each magnetic generating section generates a magnetic field with the like pole.

Being the same as the internal stator, the external stator is also secured on the housing. The external stator has a plurality of magnetic corresponding sections circularly disposed at the external side of the annular magnetic section coaxially, and corresponding to the magnetic segments one by one. Meanwhile, a part of the magnetic corresponding sections correspond to the magnetic generating sections. The pole of the magnetic corresponding sections that correspond to the magnetic generating sections is the same as that of the magnetic generating sections; and the pole of the other magnetic corresponding sections is different from that of the magnetic generating sections. Being the same as the magnetic generating section, the magnetic corresponding section includes a pillar and a coil that surrounds the pillar. Moreover, once being powered on, the pole of the magnetic field generated by the magnetic corresponding sections that correspond to the magnetic generating sections is the same as that of the magnetic field generated by the magnetic generating sections. However, the pole of the magnetic field generated by the other magnetic corresponding sections that do not correspond to the magnetic generating sections is different from that of the magnetic field generated by the magnetic generating sections.

Once the motor is powered on, the magnetic corresponding sections and the magnetic generating sections continuously vary the pole synchronously, such that each magnetic segment of the middle rotor generates a force for rotating the middle rotor under the principles that the like poles are repulsive to each other or unlike poles are attractive to each other respectively.

The present invention is improved through the following manners. (1) The internal stator or the external stator is directly formed by extending from the housing. (2) The annular magnetic section is designed into an inverted U-shaped cover body, and the revolving shaft is formed by extending from the axle center of the cover body. (3) The magnetic segments are circularly disposed at an internal edge and an external edge of the middle rotor respectively. The poles of the adjacent magnetic segments are unlike. However, the magnetic segments at the internal edge correspond to those at the external edge one by one. Meanwhile, the corresponding magnetic segments have the like pole. (4) The internal stator has three, four, or five magnetic generating sections. The middle rotor has six, eight, or ten magnetic segments corresponding to the internal stator. The external stator has magnetic corresponding sections corresponding to the magnetic segments, and the number of the magnetic corresponding sections is the same as that of the magnetic segments. Moreover, the positions of the internal stator, the middle rotor, and the external stator are arranged corresponding to each other.

The present invention not only solves the defects of the prior art, but also has advantages that are difficult to be achieved in the prior art. (1) The middle rotor is rotated under both an external pushing force and an external attractive force that are generated by the internal stator and the external stator simultaneously due to the effect that the like poles are repulsive to each other or unlike poles are attractive to each other. The external force is obviously stronger than that generated by using a single stator corresponding to the rotor in the prior art. Thus, the middle rotor in the present invention comes into a high speed rotating state during a short time period and the rotating speed is relatively high. Meanwhile, the shaft diameter of the middle rotor is not limited, so that a stronger torque may be generated. (2) By using a double-stator structure having the internal and external stators, a pushing force and an attractive force that may counteract with each other are simultaneously generated corresponding to the internal and external sides of the middle rotor. Therefore, a stabilized effect is achieved while the middle rotor is rotated.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below for illustration only, and thus is not limitative of the present invention, and wherein:

FIG. 1A is a schematic view of a first aspect of the prior art;

FIG. 1B is a schematic view of a second aspect of the prior art;

FIG. 2A is a 3-dimensional cutaway view of a first preferred embodiment of the present invention;

FIG. 2B is a cross-sectional top view of the first preferred embodiment of the present invention;

FIG. 2C is a side view of the first preferred embodiment of the present invention;

FIG. 3A shows the magnetic poles' corresponding positions in the first preferred embodiment of the present invention;

FIG. 3B shows the middle rotor's movement in the first preferred embodiment of the present invention;

FIG. 4A is a top cross-sectional view of a second preferred embodiment of the present invention; and

FIG. 4B is a top cross-sectional view of a third preferred embodiment of the present invention.

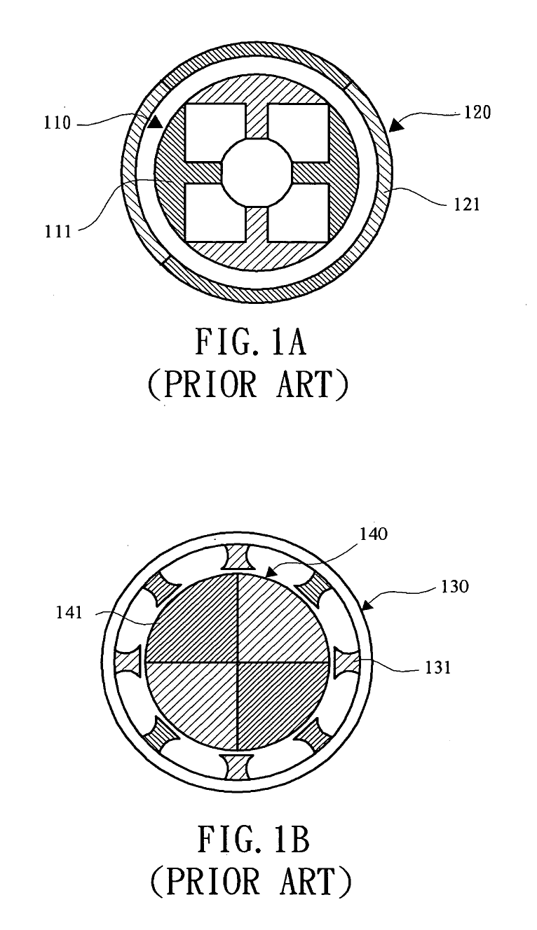

### DETAILED DESCRIPTION OF THE INVENTION

To further understand the objective, configuration characteristics, and function of the present invention, the present invention is illustrated below in detail with reference to relevant embodiments and drawings.

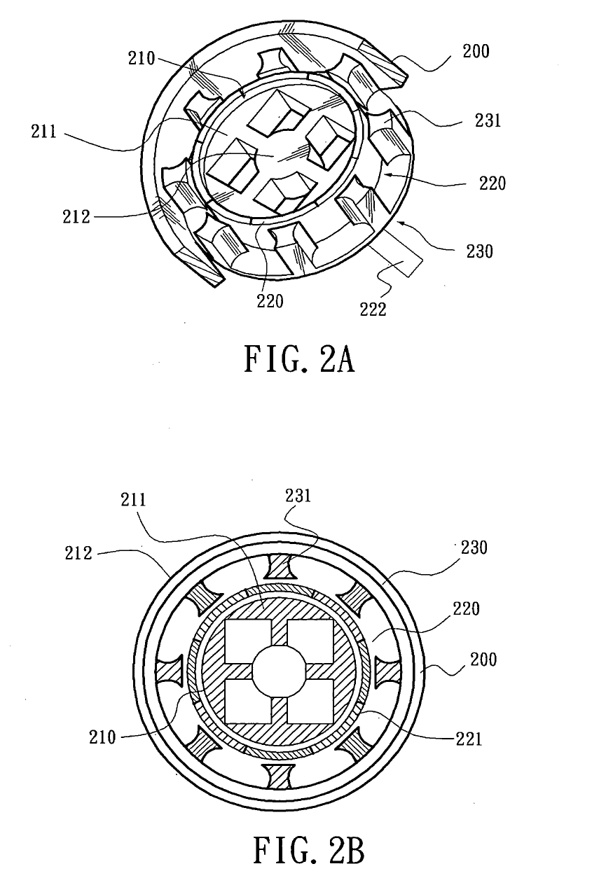

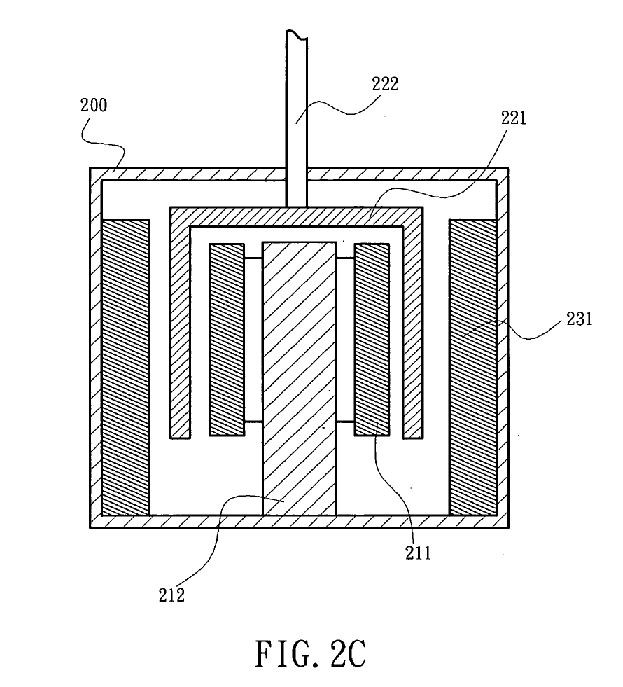

As shown in FIGS. 2A, 2B, and 2C, they are a 3-dimentional cutaway view, a side view, and a cross-sectional top view of a motor structure of the present invention. The motor structure mainly includes a housing 200, a middle rotor 220, an internal stator 210, and an external stator 230.

The middle rotor 220 has a revolving shaft 222 and an annular magnetic section 221. The revolving shaft 222 is pivotally mounted on the housing 200. The annular magnetic section 221 is an inverted U-shaped cover body in this embodiment, which is coaxially fitted to the revolving shaft 222. The annular magnetic section 221 has a plurality of circularly disposed magnetic segments and poles of the adjacent magnetic segments are unlike. In this embodiment, the annular magnetic section 221 has eight magnetic segments.

The internal stator 210 has a shaft body 212 and a plurality of magnetic generating sections 211 with the like pole. The shaft body 212 is fixedly disposed on the housing 200 by means of being coaxial with the revolving shaft 222. The magnetic generating sections 211 are circularly disposed at the peripheral edge of the shaft body 212. The magnetic generating sections 211 are disposed at the internal side of the annular magnetic section 221 by means of being coaxial with the annular magnetic section 221. Moreover, the magnetic generating sections 211 alternately correspond to the magnetic segments of the annular magnetic section 221. The “alternately correspond” mentioned herein means that when the poles of the adjacent magnetic segments are unlike, the magnetic generating sections 211 correspond to magnetic segments with the like pole at the same time, thus, the magnetic segment to which each of the magnetic generating sections 211 corresponds is spaced apart by a magnetic segment with a unlike pole. For example, if all the magnetic segments of the annular magnetic section 221 are divided into two categories, one is N-pole magnetic segments with the pole as N; and the other is S-pole magnetic segments with the pole as S. The N-pole magnetic segments and the S-pole magnetic segments are alternately arranged on the annular magnetic section 221, so as to achieve the effect that “the poles of the adjacent magnetic segments are unlike”. The magnetic generating sections 211 completely correspond to all the N-pole magnetic segments or all the S-pole magnetic segments one by one. For example, if now all the magnetic generating sections 211 correspond to all the N-pole magnetic segments one by one, no magnetic generating section 211 corresponds to any S-pole magnetic segment.

The external stator 230 is also secured to the housing 200 and has a plurality of magnetic corresponding sections 231. The magnetic corresponding sections 231 are circularly disposed at the external side of the annular magnetic section 221 coaxially. The number of the magnetic corresponding sections 231 is equal to that of the magnetic segments of the annular magnetic section 221. The magnetic corresponding sections 231 correspond to the magnetic segments one by one. A part of the magnetic corresponding sections 231 correspond to the magnetic generating sections 211 at the same time and have the same pole as that of the magnetic generating sections 211. The pole of the other magnetic corresponding sections 231 is different from that of the magnetic generating sections 211.

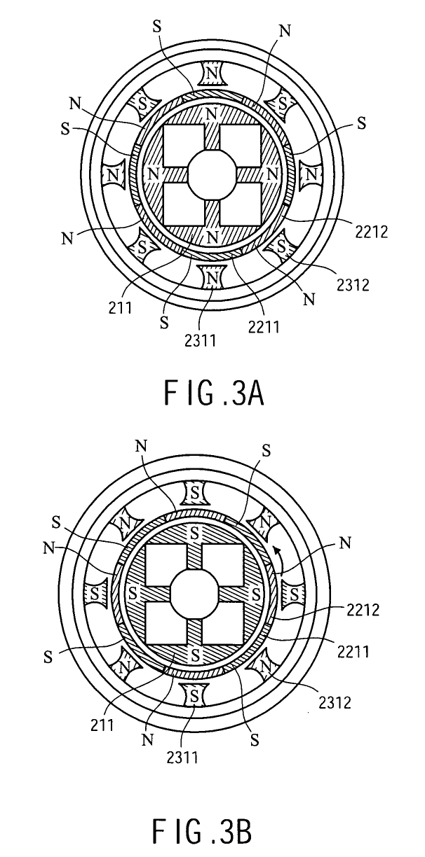

As shown in FIGS. 3A and 3B, they are schematic views showing the operations of the motor of the present invention. When the motor is powered on and at a first time, the poles of the magnetic generating sections 211 and the corresponding odd-numbered magnetic corresponding sections 2311 are both N pole, corresponding to the S-pole magnetic segments 2211. The pole of the even-numbered magnetic corresponding sections 2312 is S-pole, corresponding to the N-pole magnetic segments 2212. At a second time, the magnetic generating sections 211 and all the magnetic corresponding sections (2311, 2312) are converted to an opposite pole, that is, the poles of the magnetic generating sections 211 and the odd-numbered magnetic corresponding sections 2311 are converted to S pole, while the pole of the even-numbered magnetic corresponding sections 2312 is converted to N pole. At the time, the magnetic generating sections 211 and the corresponding odd-numbered magnetic corresponding sections 2311 generate a pushing force due to being repulsive to the S-pole magnetic segments 2211 with the like pole as the magnetic generating sections 211 and the corresponding odd-numbered magnetic corresponding sections 2311; and the even-numbered magnetic corresponding sections 2312 generate a pulling force due to being attractive to the S-pole magnetic segments 2211 with a unlike pole from that of the even-numbered magnetic corresponding sections 2312, thereby driving the middle rotor to rotate in a clockwise or anticlockwise direction. Moreover, through continuously varying the poles of the magnetic generating sections 211 and the magnetic corresponding sections (2311, 2312), the middle rotor is driven all the time. Thus, the middle rotor generates a high speed rotation in a short time period.

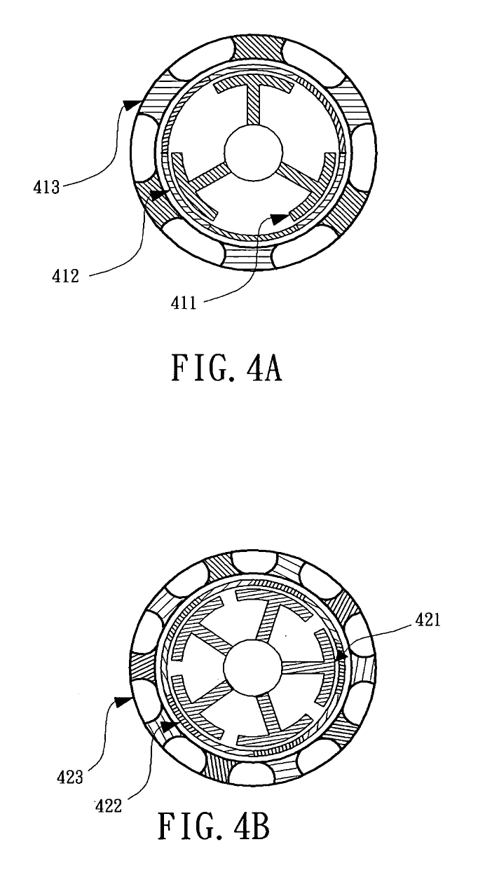

As shown in FIGS. 4A and 4B, they show a second preferred embodiment and a third preferred embodiment of the present invention respectively. The internal stators (411,421) are designed to have three or five magnetic generating sections. The annular magnetic sections of the middle rotors (412, 422) have six or ten circularly disposed magnetic segments corresponding to the number of the magnetic generating sections. The external stators (413, 423) have the magnetic corresponding sections with the number corresponding to that of the magnetic segments. Moreover, the positions of the internal stators (411, 421), the middle rotors (412, 422), and the external stators (413, 423) are arranged corresponding to each other.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

1. A motor structure, comprising:
a housing;
a middle rotor, having a revolving shaft and an annular magnetic section that are coaxially fitted to each other, the revolving shaft being pivotally mounted at the housing, the annular magnetic section having a plurality of circularly adjoining disposed magnetic segments with poles of adjacent magnetic segments being unlike;
an internal stator, secured to the housing and having a plurality of magnetic generating sections with the like pole, the magnetic generating sections being circularly disposed at an internal side of the annular magnetic section coaxially, and alternately corresponding to the magnetic segments; and
an external stator, secured to the housing and having a plurality of magnetic corresponding sections, the magnetic corresponding sections being circularly disposed at an external side of the annular magnetic section coaxially and corresponding to the magnetic segments one by one; the pole of the magnetic corresponding sections that correspond to the magnetic generating sections being the same as that of the magnetic generating sections; and the pole of the other magnetic corresponding sections being different from that of the magnetic generating sections;
wherein while the middle rotor is rotated at a pre-determined distance by the repulsion from the like poles, the pole of the magnetic generating sections and the magnetic corresponding sections are varied simultaneously such that the pole of the magnetic generating sections and the magnetic corresponding sections corresponding to the magnetic generating sections are converted to a like pole as the magnetic segments corresponding to the magnetic corresponding sections.

2. The motor structure as claimed in claim 1, wherein the magnetic generating section includes a pillar and a coil that surrounds the pillar.

3. The motor structure as claimed in claim 2, wherein the generation of the like pole for the magnetic generating sections means that magnetic fields with the like pole are generated once the magnetic generating sections are powered on.

4. The motor structure as claimed in claim 1, wherein the magnetic corresponding section includes a pillar and a coil that surrounds the pillar.

5. The motor structure as claimed in claim 4, wherein once being powered on, the magnetic generating sections and the magnetic corresponding sections that correspond to the magnetic generating sections generate magnetic fields with the like pole; and once being powered on, the pole of the magnetic field generated by the other magnetic corresponding sections is different from that of the magnetic field generated by the magnetic generating sections.

6. The motor structure as claimed in claim 1, wherein the annular magnetic section is an inverted U-shaped cover body, and the revolving shaft is formed by extending from the axle center of the cover body.

7. The motor structure as claimed in claim 1, wherein the internal stator has three, four, or five magnetic generating sections; the middle rotor has six, eight, or ten magnetic segments corresponding to the internal stator; and the external stator has six, eight, or ten magnetic corresponding sections corresponding to the magnetic segments.

8. The motor structure as claimed in claim 1, wherein the magnetic segments are circularly disposed at an internal edge and an external edge of the middle rotor; the magnetic segments at the internal edge correspond to the magnetic segments at the external edge one by one; poles of adjacent magnetic segments are unlike; and poles of the corresponding magnetic segments are the like.

9. The motor structure as claimed in claim 1, wherein a surface area of each of the magnetic generating sections is greater than a surface area of each of the magnetic segments.

10. The motor structure as claimed in claim 1, wherein a surface area of each of the magnetic generating sections is equal to a surface area of each of the magnetic segments.
